(19) United States
(12) Patent Application Publication
(10) Pub. No.: US 2011/0243309 A1
(43) Pub. Date: Oct. 6, 2011

(54) LIFT APPARATUS FOR SUPPORTING C-ARM OR U-ARM AND MEDICAL X-RAY MACHINE HAVING THE SAME

(76) Inventor: Ding Weijiang, Beijing (CN)

(21) Appl. No.: 13/077,107

(22) Filed: Mar. 31, 2011

(30) Foreign Application Priority Data
Mar. 31, 2010 (CN) 201010157067.8

(51) Int. Cl. B66F 3/24; F16M 11/28; H05G 1/02

(52) U.S. Cl. 378/197; 248/404

(57) ABSTRACT

A lift apparatus for supporting a C-arm or a U-arm of an X-ray machine is provided. The lift apparatus includes an outer shell and an inner shell disposed within the outer shell and configured to slide upward and downward within the outer shell. The C-arm or U-arm is connected to the inner shell. A gas spring is disposed within the inner shell. A first end of the gas spring is connected to a top of the inner shell, and a second end of the gas spring is connected to a bottom of the outer shell through a bottom of the inner shell. Upward and downward movement of the inner shell is driven by expansion and compression of the gas spring.

### CROSS REFERENCE TO RELATED APPLICATIONS

This application claims the benefit of Chinese Patent Application No. 201010157067.8 filed Mar. 31, 2010, which is hereby incorporated by reference in its entirety.

### BACKGROUND OF THE INVENTION

The present invention relates to a technical field of medical X-ray system and, particularly, to a lift apparatus for supporting a C-arm or a U-arm in an X-ray machine and the X-ray machine using the lift apparatus.

The C-arm or U-arm of the existing mobile X-ray machine is moved upward or downward usually by pushing a rod by a motor to make an inner shell sliding upward or downward within an outer shell, as disclosed in the U.S. Pat. No. 5,544,217. However, the one used in the prior art is driven by the motor so that it can be ascended or descended only when a surgical doctor has to always push a button during operation. Such a technique causes that the doctor cannot determine the position fast, so it is inconvenient for doctor's operation. Meanwhile, the prior art is noisy and its configuration cost is high.

### BRIEF DESCRIPTION OF THE INVENTION

The present embodiments provide a lift apparatus for supporting a C-arm or a U-arm in an X-ray machine that can solve the aforesaid problem. The lift apparatus can be operated simply, determine position fast, and be made with a relatively low cost.

The present embodiments further provide a medical X-ray machine that can solve the aforesaid problem. The medical X-ray machine can be operated simply, determine position fast, and be made at a relatively low cost.

The lift apparatus for supporting a C-arm or a U-arm in an X-ray machine provided herein includes an outer shell, and an inner shell, wherein the inner shell is disposed within the outer shell and is configured to slide upward or downward within the outer shell. The C-arm or U-arm is connected to the inner shell. The apparatus further includes a gas spring disposed within the inner shell. One end of the gas spring is connected to the top of the inner shell, and the other end of the gas spring is connected to the bottom of the outer shell through the bottom of the inner shell. The inner shell sliding upward or downward is driven by expansion and compression of the gas spring.

The lift apparatus for supporting a C-arm or a U-arm of an X-ray machine further includes an electromagnetic lock which is disposed within the inner shell. The electromagnetic lock includes a slider, and the inner shell is locked or released through extending and compressing of the slider.

The gas spring is connected in a hinge joint way to the top of the inner shell and the bottom of the outer shell.

The gas spring includes an airproof barrel and a gasspring rod. One end of the gasspring rod is partially inserted into the airproof barrel and is configured to slide upward or downward within the airproof barrel. The other end of the gasspring rod is hinged to the top of the inner shell. The bottom of the airproof barrel is hinged to the bottom of the outer shell.

The airproof barrel is hinged to the outer shell. More specifically, a lug is disposed on the bottom of the outer shell and a supporting seat is disposed on the lug; pivot holes are disposed on the corresponding position on the bottoms of the lug, supporting seat and airproof barrel; the bottom of the airproof barrel is inserted into the lug through the supporting seat; and the airproof barrel is hinged to the bottom of the outer shell through a pivot inserted in the pivot holes.

There are two sets of gas springs.

The electromagnetic lock further ε includes a lock shell, which is against the inner sidewall of the inner shell. The slider is disposed within the lock shell and is configured to be extended out of the lock shell or compressed back into the lock shell. An opening is disposed on the corresponding position where the inner shell is against the lock shell in order that the slider may go through the opening against the inner sidewall of the outer shell after extending out of the lock shell so as to lock the inner shell.

The electromagnetic lock is switched on or off by an electrical operation button.

The lock shell is a coil. The slider is an electromagnet that is inserted into the coil. The electrical operation button controls a current loop to supply power to or cut power off from the coil.

The outer shell is a barrel-shape on the top of which an opening is disposed. The inner shell is the barrel-shape the bottom of which is cut through and on the top of which a lid is disposed.

The X-ray machine provided herein includes a C-arm or a U-arm, a lift apparatus, and a control system. The lift apparatus includes an outer shell and an inner shell. The inner shell is disposed within the outer shell and is configured to slide upward or downward therein. The C-arm or U-arm is connected to the inner shell. The control system controls the lift apparatus of the C-shape arm to be locked during the lifting process. The X-ray machine further includes a gas spring disposed within the inner shell. One end of which is connected to the top of the inner shell, and the other end of which is connected to the bottom of the outer shell through the bottom of the inner shell. The inner shell is driven to slide upward or downward by expansion and compression of the gas spring.

The X-ray machine further includes an electromagnetic lock which is disposed within the inner shell. The electromagnetic lock includes a slider, and the inner shell is locked or released through extending and compressing of the slider.

The gas spring is connected in a hinge joint way to the top of the inner shell and the bottom of the outer shell.

The gas spring includes an airproof barrel and a gasspring rod. One end of the gasspring rod is partially inserted into the airproof barrel and is configured to slide upward or downward therein, and the other end of the gasspring rod is hinged to the top of the inner shell. The bottom of the airproof barrel is hinged to the bottom of the outer shell.

The airproof barrel is hinged to the outer shell. More specifically, a lug is disposed on the bottom of the outer shell and a supporting seat is disposed on the lug; pivot holes are disposed on the corresponding position on the bottoms of said lug, supporting seat and airproof barrel; the bottom of the airproof barrel is inserted into the plug through the supporting seat; and the airproof barrel is hinged to the bottom of the outer shell through a pivot inserted in said pivot holes.

There are two sets of gas springs.

The electromagnetic lock further includes a lock shell which is against the inner sidewall of the inner shell. The slider is disposed within the lock shell and is configured to be extended out of the lock shell or compressed back to the lock shell. An opening is disposed on the corresponding position where the inner shell is against the lock shell in order that the slider may go through the opening against the inner sidewall of the outer shell after extending out of the lock shell so as to lock the inner shell.

The electromagnetic lock is switched on or off by an electrical operation button on the control system.

The lock shell is a coil. The slider is an electromagnet that is inserted into the coil. The control system further includes a current loop connected to the coil. The electrical operation button controls the current loop to supply power to or cut power off from the coil.

The outer shell is a barrel-shape on the top of which an opening is disposed. The inner shell is the barrel-shape the bottom of which is cut through and on the top of which a lid is disposed.

The present embodiments, through the gas spring with low costs and incorporation of the electromagnetic lock and by means of the features of the gas spring can make the C-arm or U-arm reach any position as long as the inner shell is slightly pushed or pulled. It facilitates doctors' operation. At the same time, the gas spring is able to effectively balance the weight of the C-arm or U-arm, and there is no noise during operation. Therefore security and stability of lifting of the C-arm or U-arm is effectively enhanced. The present embodiments further have advantages such as simple structure and low cost.

### BRIEF DESCRIPTION OF THE DRAWINGS

FIG. 1 is a structure schematic diagram of the lift apparatus for supporting a C-arm or a U-arm in an X-ray machine.

FIG. 2 is a cross schematic diagram of the lift apparatus of FIG. 1.

FIG. 3 is the structure schematic diagram for positioning the electromagnetic lock to lock the inner shell.

FIG. 4 is the structure schematic diagram of the medical X-ray machine using the lift apparatus.

FIG. 5 is the loop schematic diagram of the control system controlling the electromagnetic lock.

### DETAILED DESCRIPTION OF THE INVENTION

In the following contents, embodiments of the present invention are illustrated according to the drawings. The present invention is not limited to the embodiments.

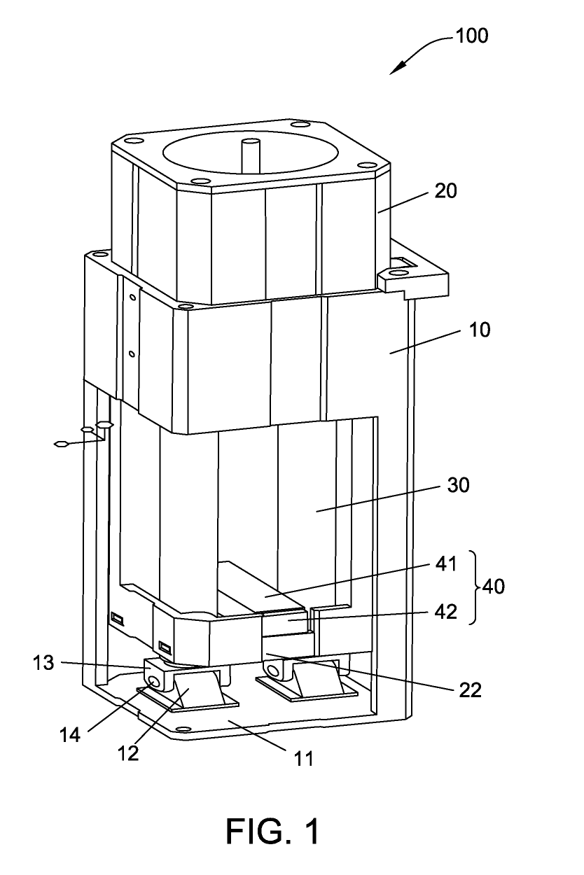

A structure schematic diagram of the lift apparatus for supporting C-arm or U-arm in an X-ray machine provided herein is illustrated in FIG. 1. The lift apparatus includes an outer shell 10, an inner shell 20, and a gas spring 30 disposed within the inner shell 20. In this structure schematic diagram, in order to clearly illustrate the outer shell 10, the gas spring 30 within the inner 20 and other members and their connection relationships, a partial outer sidewall of the outer shell 10 and the inner shell 20 are cut off to reveal their inner structure and other members therein. The outer shell 10 is a barrel-shape structure the top of which is open. The inner shell 20 is enclosed within the outer shell 10. It is the barrel structure the top of which is an opening disposed with a lid (not shown in the illustration) and the bottom of which is cut through. The supported C-arm or U-arm of the X-ray machine is fixed to the top of the inner shell 20.

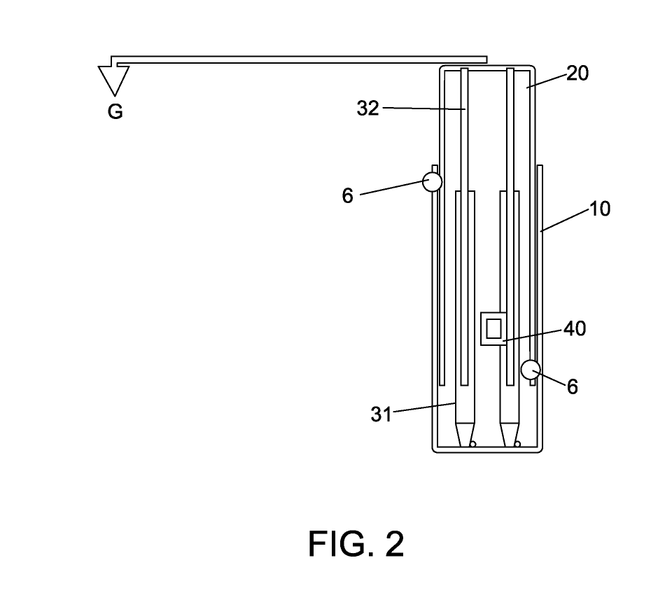

Referring to FIG. 2, the inner shell 20 can slide upward or downward within the outer shell 10 so as to drive the C-arm or U-arm upward or downward. In order to reduce friction when the inner shell 20 is sliding on the inner sidewall of the outer shell 10, a bearing 6 is disposed between the outer shell 10 and the inner shell 20. In this embodiment, there are two sets of bearings 6. One set is fixed on the outer shell 10. When the inner shell 20 slides upward or downward within the outer shell 10, the bearings 6 roll forwards and backwards on the inner shell 20. The other set of bearings 6 is fixed on the inner shell 20. When the inner shell 20 slides upward or downward within the outer shell 10, the bearings 6 roll forwards and backwards on the outer shell 10, which reduces the fiction between the inner shell 20 and the outer shell 10. The gas spring 30 includes an airproof barrel 31 and a gasspring rod 32. One end of the gasspring rod 32 is partially inserted into the airproof barrel 31 from one end of the airproof barrel 31. The bottom of the other end of the airproof barrel 31 is hinged to the bottom 11 of the outer shell 10.

Referring again to FIG. 1, the bottom of the other end of said airproof barrel 31 goes through a supporting seat 13 into a lug 12 by disposing the lug 12 on the bottom of the outer shell 10 and the supporting seat 13 disposed on the lug. Pivot holes 14 are disposed on the corresponding positions on the bottoms of the lug 12, the supporting seat 13, and the airproof barrel 31. The airproof barrel 31 is hinged to the bottom 11 of the outer shell 10 with a pivot (not shown in the Figure) through the pivot holes 14. The other end of the gasspring rod 32 is hinged to a lid on the top of the inner shell 20. There may be one set or more sets of gas springs 30. In this embodiment, there are two sets. The feature of the gas spring is: when the additional load is equal to elasticity of the gas spring, as long as an initial force is given to the gasspring rod, namely, pressing downward or pulling upward on it once, it will automatically continuously be compressed downward or expanded upward. It is unnecessary to always be pushed or pulled artificially. Therefore, in this invention, as long as the inner shell 20 is pushed downward or the inner shell 20 is pulled upward, the gas spring 30 will automatically continuously go downward or expand upward so as to drive the inner shell 20 to slide downward or upward within the outer shell 10. The inner shell 20 drives the C-arm or U-arm supported by it to move upward or downward. It is unnecessary for a doctor to always pull or push it so as to save the unnecessary operation for the doctor.

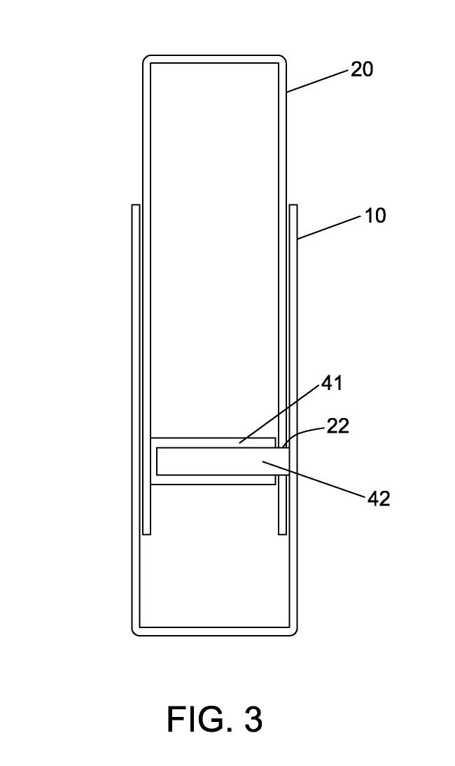

In order to control and position sliding of the inner shell 20, the present embodiments use an electromagnetic lock 40 to position and lock sliding of the inner shell 20. The electromagnetic lock 40 is disposed within the inner shell 20, which includes a lock shell 41 and a slider 42 against the inner sidewall of the inner shell 20. The slider 42 is configured to be extended out of the lock shell 41 or compressed back into the lock shell 41. An opening 22 is disposed on the position where the lock shell 41 is against the inner 20. When the slider 42 extends out of the lock shell 41 and goes through the opening 22 to be against the inner sidewall of the outer shell 10, namely, locking the inner shell 20, it is positioned, as illustrated in FIG. 3. The electromagnetic lock 40 controls extension and compression of the slider 42 by an electrical operation button (not shown in the figure), namely, the electromagnetic lock 40 is switched on or off by the electrical operation button. An ideal manner is that such electromagnetic lock 40 is disposed within the lower portion or close to the bottom of the inner shell 20 to avoid that the electromagnetic lock 40 cannot lock the inner shell 20 when the inner shell 20 ascends to a certain position.

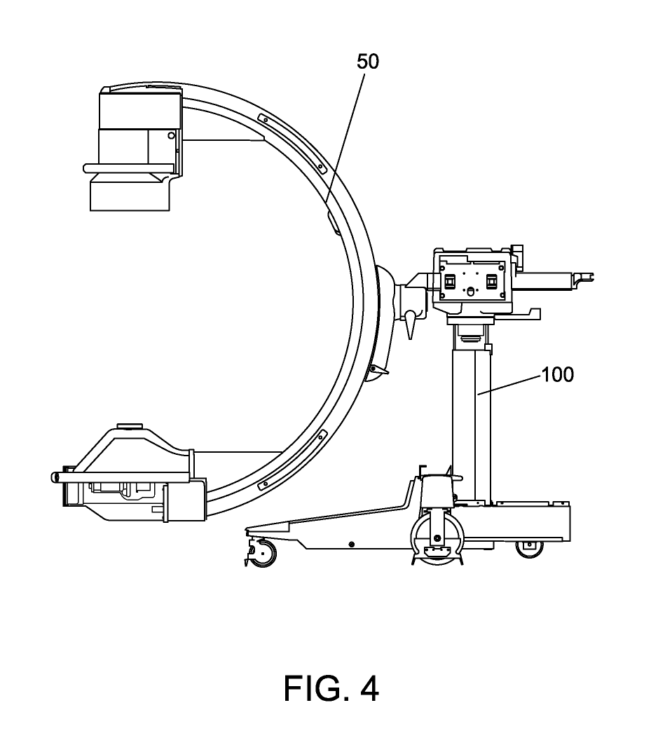

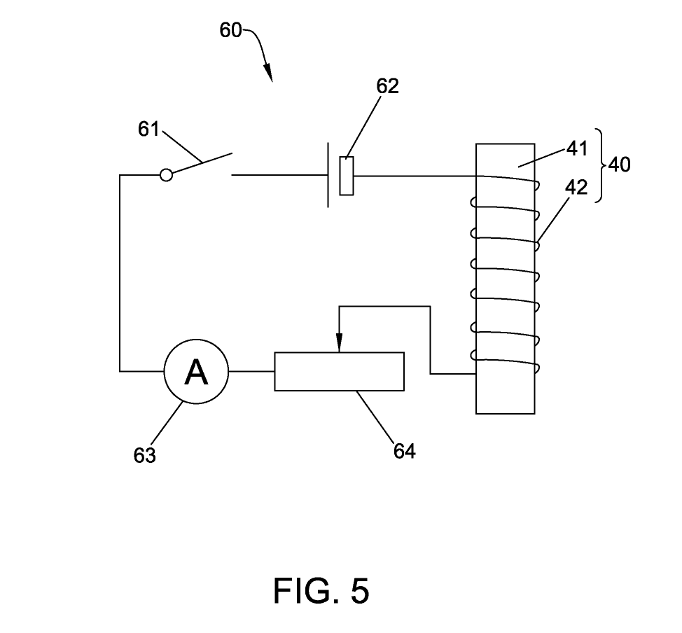

As illustrated in FIG. 4, an X-ray machine using the support lift apparatus includes a C-shape arm 50, a lift apparatus 100, and a control system 60 (as illustrated in FIG. 5) for controlling locking and lifting of the X-ray machine. The C-shape arm 50 is fixed and connected to the lift apparatus 100. The control system 60 controls the lift apparatus 100 to be locked during the lifting process. The structure of the lift apparatus 100 is stated in the preceding contents, and it will not be repeated any more. FIG. 5 is a current loop schematic diagram where the control system 60 controls the electromagnetic lock 40. The loop includes a switch 61, a power source 62, an ampere meter 63, and a variable resistance 64. The outer shell 42 of the electromagnetic lock 40 is a coil. The slider 42 is an electromagnet. The electrical operation button is the switch 61 in the present embodiment. When switch 61 is switched on, current passes through the coil to produce an electromagnetic field around it. The electromagnet is pushed by the pushing force of the electromagnetic field to move against the inner sidewall of the outer shell 10 so as to lock the inner shell 20. When the switch 61 is switched off, the electromagnetic field on the coil disappears, thus the electromagnet moves back to the original position and the inner shell 20 is released. When a hand is used to slightly push or pull the inner shell 20, under the function of the gas spring 30, the inner shell 20 can move downward or upward, and the C-shape arm 50 supported thereon moves upward or downward together. When an ideal position is arrived, the electrical operation button on the control system 60 is operated to control the electromagnetic lock 40 to lock the inner shell 20.

Reference G in FIG. 2 represents the position of load and weight of the C-arm or U-arm. The lifting structure described herein can preferably balance the load and weight of the C-arm or U-arm so as to make stability of the X-ray machine better.

The above-described embodiments, through the gas spring with low costs and incorporation of the electromagnetic lock and by means of the features of the gas spring can make the C-arm or U-arm reach any position as long as the inner shell is slightly pushed or pulled. It facilitates doctors' operation. At the same time, the gas spring is able to effectively balance the weight of the C-arm or U-arm, and there is no noise during operation. Therefore, security and stability of lifting of the C-arm or U-arm are effectively enhanced.

1. A lift apparatus for supporting a C-arm or a U-arm of an X-ray machine, said lift apparatus comprising:
an outer shell;
an inner shell disposed within the outer shell and configured to slide upward and downward within the outer shell, said C-arm or U-arm is connected to the inner shell; and
a gas spring disposed within the inner shell, a first end of the gas spring is connected to a top of the inner shell and a second end of the gas spring is connected to a bottom of the outer shell through a bottom of the inner shell, wherein upward and downward movement of the inner shell is driven by expansion and compression of the gas spring.

2. The lift apparatus according to claim 1, comprising an electromagnetic lock disposed within the inner shell, the electromagnetic lock comprises a slider configured to lock and release the inner shell by extending and compressing the slider.

3. The lift apparatus according to claim 1, wherein the gas spring is hingedly connected to the top of the inner shell and the bottom of the outer shell.

4. The lift apparatus according to claim 3, wherein said gas spring comprises an airproof barrel and a gasspring rod, a first end of the gasspring rod is partially inserted into the airproof barrel and is configured to slide upward and downward within the airproof barrel and a second end of the gasspring rod is hinged to the top of the inner wherein a bottom of said airproof barrel is hinged to the bottom of the outer shell.

5. The lift apparatus according to claim 4, further comprising:
a lug disposed on the bottom of the outer shell;
a supporting seat disposed on the lug;
pivot holes defined at corresponding positions on a bottom of the lug, a bottom of said supporting seat, and a bottom of said airproof; barrel, wherein the bottom of the airproof barrel is inserted into the lug through the supporting seat; and
a pivot inserted into said pivot holes to hinge the airproof barrel to the bottom of the outer shell.

6. The lift apparatus according to claim 5, further comprising two sets of said gas springs.

7. The lift apparatus according to claim 2, wherein said electromagnetic lock further comprises:
a lock shell positioned against an inner sidewall of the inner; shell, said slider disposed within the lock shell and configured to be extended out of the lock shell and compressed into the lock shell; and
an opening defined in the inner shell at a position where the inner shell is against the lock shell such that the slider extends from the lock shell through the opening against an inner sidewall of the outer shell to lock the inner shell.

8. The lift apparatus according to claim 7, further comprising an electrical operation button configured to switch said electromagnetic lock on and off.

9. The lift apparatus according to claim 8, wherein:
said lock shell comprises a coil;
said slider comprises an electromagnet inserted into the and
a current loop controlled by said electrical operation button a current loop to supply power to and cut power off from the coil.

10. The lift apparatus according to claim 1, wherein:
said outer shell comprises a barrel-shape portion having an opening defined on a top thereof; and
said inner shell comprises a barrel-shape portion having a cut through defined through a bottom thereof and a lid disposed on a top thereof.

11. An X-ray machine comprising:
a C-arm or a U-arm;
a lift apparatus comprising an outer shell and an inner shell disposed within the outer shell and configured to slide upward and downward within the outer shell, wherein said C-arm or U-arm is connected to the inner shell;
a control system configured to lock the lift apparatus during a lifting process; and
a gas spring disposed within the inner shell, a first end of the gas spring is connected to a top of the inner shell and a second end of the gas spring is connected to a bottom of the outer shell through a bottom of the inner; shell, wherein upward and downward movement of the inner shell is driven through expansion and compression of the gas spring.

12. The X-ray machine according to claim 11, comprising an electromagnetic lock disposed within the inner shell, the electromagnetic lock comprises a slider configured to lock and release the inner shell through extending and compressing the slider.

13. The X-ray machine according to claim 11, wherein said gas spring is hingedly connected to the top of the inner shell and the bottom of the outer shell.

14. The X-ray machine according to claim 13, wherein said gas spring comprises an airproof barrel and a gasspring rod, a first end of the gasspring rod is partially inserted into the airproof barrel and is configured to slide upward and downward within the airproof barrel and a second end of the gasspring rod is hinged to the top of the inner wherein a bottom of said airproof barrel is hinged to the bottom of the outer shell.

15. The X-ray machine according to claim 14, further comprising:
a lug disposed on the bottom of the outer shell;
a supporting seat disposed on the lug;
pivot holes defined at corresponding positions on a bottom of the lug, a bottom of said supporting seat, and a bottom of said airproof barrel, wherein the bottom of the airproof barrel is inserted into the lug through the supporting seat; and
a pivot inserted into said pivot holes to hinge the airproof barrel to the bottom of the outer shell.

16. The X-ray machine according to claim 15, further comprising two sets of said gas springs.

17. The X-ray machine according to claim 12, wherein said electromagnetic lock further comprises:
a lock shell positioned against an inner sidewall of the inner shell, said slider disposed within the lock shell and configured to be extended out of the lock shell and compressed into the lock shell; and
an opening defined in the inner shell at a position where the inner shell is against the lock shell such that the slider extends from the lock shell through the opening against an inner sidewall of the outer shell to lock the inner shell.

18. The X-ray machine according to claim 17, further comprising an electrical operation button configured to switch said electromagnetic lock on and off.

19. The X-ray machine according to claim 18, wherein:
said lock shell comprises a coil;
said slider comprises an electromagnet inserted into the coil;
said control system comprises a current loop connected to the coil, wherein the electrical operation button is configured to control the current loop to supply power to and cut power off from the coil.

20. The X-ray machine according to claim 11, wherein:
said outer shell comprises a barrel portion having an opening defined on a top thereof; and
said inner shell comprises a barrel portion having a cut through defined through a bottom thereof and a lid disposed on a top thereof.
